(19) United States
(12) Patent Application Publication
(10) Pub. No.: US 2022/0020040 A1
(43) Pub. Date: Jan. 20, 2022

(54) SYSTEMS AND METHODS FOR DETECTING AND ANALYZING RESPONSE BIAS

(71) Applicants: ARIZONA BOARD OF REGENTS ON BEHALF OF THE UNIVERSITY OF ARIZONA, Tucson, AZ (US); Brigham Young University, Provo, UT (US)

(72) Inventors: Joseph S. Valacich, Tucson, AZ (US); Jeffrey L. Jenkins, Provo, UT (US)

(21) Appl. No.: 17/295,021

(22) PCT Filed: Nov. 15, 2019
(86) PCT No.: PCT/US2019/061817

§ 371 Date: May 18, 2021

Related U.S. Application Data
(60) Provisional application No. 62/769,342, filed on Nov. 19, 2018.

(51) Int. Cl. G06Q 30/02; G06F 11/34; G06F 17/18

(52) U.S. Cl. CPC G06Q 30/0203; G06F 17/18; G06F 11/3438; G06Q 30/0201

(57) ABSTRACT

Systems and methods for identifying response bias are disclosed. In certain embodiments, the systems and methods receive data associated with a user's input device in the course of a survey and calculate one or more metrics from the data. Metrics are a measure of the movements of the input device. The systems and methods then calculate the user's response bias from the metrics and output results of the survey. In that output, the results are adjusted for the user's response bias.

### CROSS-REFERENCE TO RELATED APPLICATIONS

This application claims the benefit of U.S. Provisional App. No. 62/769,342, filed Nov. 19, 2018, the entire contents of which are hereby incorporated by reference.

### FIELD OF THE INVENTION

The present invention relates to systems and methods for detecting and adjusting for response bias, and in particular to systems and methods for detecting and adjusting for response bias in aggregated data collected in online surveys.

### BACKGROUND OF THE INVENTION

Surveys—a research instrument that asks a sample population one or more questions—are among the most common methodologies for collecting human response data in both academic and industry settings. Given the ubiquitous nature of the Internet as well as personal computers and mobile devices, most academic and industry-focused surveys are delivered to respondents using an online survey delivery platform. For instance, using the quoted search phrase “online survey” in Clarivate Analytics' Web of Science search engine, resulted in more than 26,000 results (Aug. 22, 2019). In Google Scholar, the same search phrase (on the same date) resulted in more than 414,000 results. Online surveys are pervasive and are utilized in a broad range of contexts.

Data from surveys is aggregated and used to make inferences about a population. Aggregating data refers to mathematically combining self-reported data from multiple respondents in an online survey into a sum, average, or other summary statistic. For example, answers to questions about product satisfaction may be aggregated to infer how satisfied a population is with a product or service. In another example, one may aggregate answers about whether people intend to adhere to a certain policy or behave in a certain way. This aggregate data may be used to make decisions, including resource allocation, product enhancements, or policy changes relevant to the population.

The marketplace for such online survey platforms was valued at US$4 billion in 2017 and is expected to have a compound annual growth rate of 11.25%, reaching a market size of nearly US$7 billion by 2022. Academic researchers as well as countless industries including retail, market research, healthcare, financial services, and manufacturing to name a few use online surveys to gain a better understanding of respondent opinions, perceptions, intentions and behaviors. Numerous survey platform providers support the online delivery of surveys including Zoho Corporation Pvt. Ltd., Medallia Inc., Confirmit, Inqwise, SurveyMonkey, Campaign Monitor, QuestionPro, and Qualtrics. Online surveys are an established and growing data collection method in nearly all public and private sectors including education, non-profits, various for-profit industries, and all governmental sectors. Most of these survey delivery platforms are cloud-based, allowing respondents to utilize a broad range of computing devices including personal computers, notebooks, tablets and mobile devices to make responses using a standard web browser or specialized app, as shown in FIG. 1.

It is with these observations in mind, among others, that various aspects of the present disclosure were conceived and developed.

### SUMMARY OF THE INVENTION

It is therefore an object of the present invention to remedy the deficiencies in the art by disclosing systems and methods that determine and adjust for response bias. In certain embodiments, the system receives data associated with a user's input device in the course of a survey and calculates one or more metrics from the data. Metrics are a measure of the interaction with the survey with an input device including navigation, item selections, and data entry. The system then calculates the user's response bias from the metrics and outputs results of the survey. In that output, the results are adjusted for the user's response bias.

It is another object of the invention to calculate the response bias as one or more response bias scores.

It is yet another object of the invention to apply signal isolation on human-computer interaction data in order to calculate the response bias.

It is yet another object of the invention to determine that response bias exists when there is a moderating relationship between items on the survey and the one or more metrics it has previously calculated.

### BRIEF DESCRIPTION OF THE DRAWINGS

FIG. 1 is an illustration showing exemplary online survey platforms supporting a broad range of device for making responses;

FIG. 2 is a flow chart showing the exemplary online survey planning, design, deployment and analysis process;

FIG. 3 is an illustration showing the exemplary mouse movements when a respondent is completing a typical online survey using a straight lining satisficing response strategy;

FIG. 4 is a flow chart showing Simon's rational decision-making model as applied to completing a survey question;

FIG. 5A is an illustration showing an exemplary low social desirability bias response;

FIG. 5B is an illustration showing an exemplary high social desirability bias response;

FIG. 6 is a flow chart showing how response biases influence how a respondent processes a question, formulates a response, and selects or generates an answer;

FIG. 7 is a graphical representation showing that some types of response biases result in faster and less deliberative responses; other types of response biases result in slower and greater deliberative responses;

FIG. 8 is an illustration showing resulting movement from primed movements to multiple stimuli with action-based potential;

FIG. 9 is an illustration showing an exemplary replay of a respondent influenced by a response bias;

FIG. 10 is an illustration showing an example of a response that provided inaccurate information due to response bias;

FIG. 11 is an illustration showing an example of a response that provided accurate information not influenced by a response bias;

FIG. 12 is an illustration showing an exemplary conceptual model of how Response Bias Scores reflecting HCl movement, behavior, and time deviation moderate the influence of a survey construct item on a predicted variable;

FIG. 13 is a flow chart showing a process for exemplarily implementing a response bias detection system into an online survey;

FIG. 14 is an illustration showing fine-grained interaction data being collected from any type of computing device;

FIG. 15 is an illustration showing the raw data collector module (RDC) recording exemplary movement and events of a respondent's interaction with a survey question;

FIG. 16 is an illustration showing exemplary mouse movement when a person completes a highly controlled research study with each sub-task being started and ended by clicking on buttons;

FIG. 17 is an illustration showing an example of a typical online survey with several questions on a single page;

FIG. 18 is a flow chart showing a Signal Isolation Algorithm comprising two primary processes;

FIG. 19 is a flow chart showing an exemplary algorithm for calculating Response Bias Scores;

FIG. 20 shows an exemplary process for implementing response bias measurement to improve data quality; and

FIG. 21 is a simplified block diagram showing an exemplary computer system for effectuating the system and method for detecting and analyzing response bias in online survey questions.

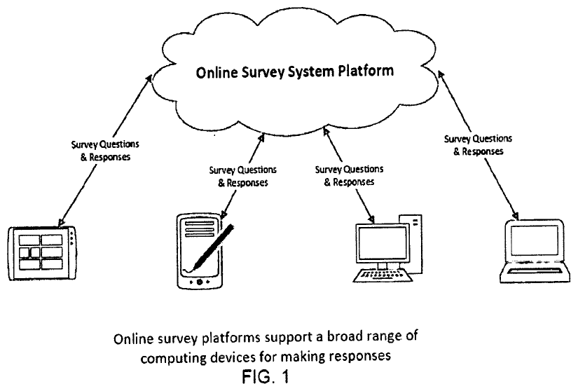

### DETAILED DESCRIPTION OF PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose. Several preferred embodiments of the invention are described for illustrative purposes; it being understood that the invention may be embodied in other forms not specifically shown in the drawings.

Surveys—a research instrument that asks a sample population one or more questions—are among the most common methodologies for collecting human response data in both academic and industry settings. Data is often aggregated across multiple questions and individuals to make an inference about the sample population. A critical threat to the validity of survey results are a category of factors referred to as response biases; i.e., a tendency of responding to questions on some basis other than the question content. Response biases can have a detrimental effect on the quality of the results of a survey study, resulting in summary statistics that do not accurately represent the sample population. The present system and method relates to how changes in hand movement trajectories and fine motor control, captured by tracking human-computer interaction (HCl) dynamics—i.e., changes in typing, mouse-cursor movements, touch pad movements, touch screen interaction, device orientation on smartphones and tablet computers, etc.—can help estimate response biases in aggregated survey data. The raw fine-grained HCl interaction data is collected at millisecond precision and converted into various statistical metrics. For a computer mouse, for example, the raw data consists of X and Y-coordinates, timestamps, and clicks. Regardless of the type of HCl device, its raw data is converted into a variety of statistical metrics related to a collection of continuous measures (e.g., movement speed, movement accuracy, completion time) and binary measures (e.g., page exits, answer switching, text entry and editing characteristics, etc.). These measures are then aggregated into a set of Response Bias Scores (RBS) that are used to moderate the relationship between a survey construct and a predicted variable to detect and adjust for response biases.

### Online Survey Design and Delivery Process

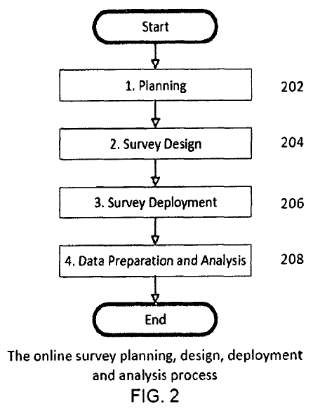

At a high-level, the execution of a successful online survey follows several steps. First, planning, where the objectives and rationale for the survey are established. Here, many planning activities can occur depending on the context including timelines, objective, research question and hypothesis development, literature review, and so on. Second, once the planning is completed, the survey design process begins, which includes the creation of the online survey, determining the target population, determining sample sizes as well as pilot testing to refine and optimize the survey language and delivery process. Third, survey deployment occurs where the online survey is sent to the target population where response rates are monitored and possible reminders are sent to any individuals who have yet to respond. Fourth, data preparation and analysis are conducted in order to produce aggregated summary statistics and a report of those findings (FIG. 2). Of course, depending on the context, variations in those steps could occur. As shown in FIG. 2, the process commences with survey planning 202 and survey design 204. At step 206, the survey is deployed, exemplarily online, to be taken by users. At step 208, the data from the survey is collected, prepared (e.g. parsed), and then analyzed to make determinations.

Data Quality Problems with Online Surveys

While there is widespread and global use of online surveys, there is a large and growing body of literature related to various data quality concerns. Many factors can cause poor data quality. First, a vast literature, generally referred to as psychometrics, relates to the theory and technique of psychological measurement. Specifically, psychometrics focuses on the development, evaluation and use of survey-based tests. Psychometrics also establishes standards related to testing operations including test design and development, scores, scales, norms, score linking, cut scores, test administration, scoring, reporting, score interpretation, test documentation, and rights and responsibilities of test takers and test users. In essence, poorly designed or poorly executed survey-based data collection leads to data quality concerns. Clearly, psychometrics plays a large and established role in determining the data quality of a survey.

In addition to survey design concerns, there are a variety of potential problems that can negatively influence the quality of survey responses such as non-response biases where people in a particular demographic fail to respond at the same rate as other populations or coverage biases where a sample is (or is not) representative of the target population. To overcome some of these threats to the validity of the results, researchers and pollsters employ a variety of sampling approaches to account for, or attempt to nullify, these possible validity threats. These avoidance and correction techniques are not only time-consuming and expensive, but their efficacy for improving the validity and clarity of results is also questionable. The focus in this innovation is not on psychometrics and basic survey design, delivery, or sampling. The focus of the present disclosure is on evaluating how human response biases influence the quality of a respondent's answers and how to apply a proxy measure for various types of response biases in predictive statistical models.

### Response Biases

Online surveys are used to test some of the most utilized theories in the behavioral sciences as well as assess values, beliefs, competency, product preference, and political opinions. Surveys are a valuable research methodology for collecting information on respondents' characteristics, actions, or opinions and also help to answer questions regarding “how” and “why”.

A threat to the validity of survey results; however, is a category of factors referred to as response biases. A response bias (also known as a survey bias) is the tendency of people to respond to questions on some basis other than the question content. For example, a person might misrepresent an answer in such a manner that others view it more favorably (i.e., a type of response bias called a social desirability bias). In general, people have the tendency to portray themselves in the best light particularly when asked about personal traits, attitudes, and behaviors, which often causes respondents to falsify or exaggerate answers. In other situations, a person might not be sure how to answer a question because of a lack of knowledge of the area or a lack of understanding of the question. Thus, there are several types of factors that can bias survey responses.

Acquiescence bias refers to the tendency of respondents to agree with all the questions in a survey. Relatedly, nay-saying is the opposite form of the acquiescence bias, where respondents excessively choose to deny or not endorse statements in a survey or measure. Demand bias refers to the tendency of respondents to alter their response or behavior simply because they are part of a study (i.e., hypothesis guessing with a desire to help or hurt the quality of the results). Extreme responding bias refers to the tendency of respondents to choose the most (or least) extreme options or answers available. Prestige bias refers to the tendency of respondents to overestimate their personal qualities. Social desirability bias, introduced above, refers to the tendency of respondents to misrepresent an answer in such a manner that others will view it more favorably. Unfamiliar content bias refers to the tendency of respondents to choose answers randomly because they do not understand the question or do not have the knowledge to answer the question. Finally, satisficing bias refers to the tendency of respondents to give less thoughtful answers due to being tired of answering questions or unengaged with the survey completion process. Table 1 provides a summary of these common types of response biases.

TABLE 1
Examples of response biases and their description

| Response Bias | Response Behavior |
|---|---|
| Acquiescence | Tendency to systematically agree (or disagree) with questions |
| Demand | Tendency to alter response to help (or hurt) research results |
| Extreme | Tendency to provide the most extreme answers available; high or low |
| responding | |
| Prestige | Tendency to overestimate personal qualities |
| Social desirability | Tendency to misrepresent information to be viewed more favorably by |
| | others |
| Unfamiliar content | Tendency to answer randomly due to a lack of understanding of the |
| | question and/or possible responses |
| Satisficing | Tendency to give less thoughtful answers due to fatigue or lack of |
| | engagement |

Response biases can have a detrimental effect on the quality of the results on inferences made from data aggregated from a survey study. For example, the significant results of a study might be due to a systematic response bias rather than the hypothesized effect. On the other hand, a hypothesized effect might not be significant because of a response bias. For example, the intention-behavior gap—a phenomenon that describes why intentions do not always lead to behaviors—may be attributed to response biases in some situations. For example, a person may give a socially desirable, yet inaccurate answer about their intentions to perform a given behavior (e.g., a New Year's resolution to increase exercising when the person knows they are not likely to change their current behavior). As a result, their behavior is not consistent with their reported intentions. Thus, in order to increase the validity of many types of survey studies, it is critical to understand and control for response biases. Response biases can lead to both Type 1 errors (i.e., detecting an effect that isn't present) and Type 2 errors (i.e., failing to detect an effect that is present).

Various strategies, primarily related to the design of research protocols and wording of the questions, help reduce response bias. Most of these strategies involve deceiving the subject, or are related to the way questions in surveys and questionnaires are presented to those in a study. None of these approaches is able to detect and measure the effects of various response biases, but simply apply empirically derived methods for reducing or identifying possible bias (see Table 2 for previously developed bias identification and reductions methods).

TABLE 2
Previous Response Bias identification and reduction methods

| Response Bias | Bias Identification and Reduction Methods |
|---|---|
| Acquiescence | Balance the number of positively and negatively worded questions. |
| Demand | Use deception to prevent the participant from discovering the true |
| | hypotheses of the survey. |
| Extreme | Carefully select respondent populations as some cultures, lower |
| responding | intelligence individuals, or particular beliefs are more likely to respond |
| | in an extreme manner as compared to others. |
| Prestige | Use deception to prevent the participant from discovering the true |
| | hypotheses of the survey. |
| Social desirability | Deceive the subject, or alter the way questions are presented in the study, |
| | including forced-choice items, neutral questions, and self-administered |
| | questionnaires. |
| Unfamiliar content | Create questions with impossible answers to identify if such items are |
| | chosen; if so, the subject is more likely to be unfamiliar with the survey |
| | content. |
| Satisficing | Use “check questions” to identify if participants remain engaged. |

### Satisficing

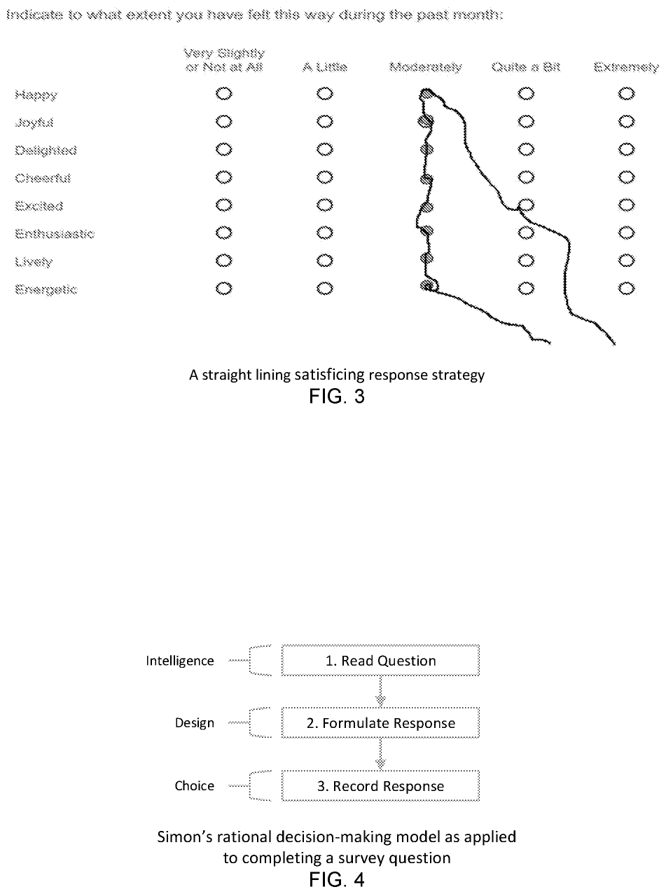

Satisficing is a decision-making strategy or cognitive heuristic that entails searching through the available alternatives until an acceptability threshold is met. Survey respondents who do not put forth maximum effort, for a variety of reasons including fatigue, feelings of compliance to a request, being required to answer in order to gain compensation, or to fulfill a requirement of a job or academic course, are following a satisficing response strategy. As such, respondents following a satisficing response strategy expend only the amount of effort needed to make an acceptable or satisfactory response. Also, respondents may begin a survey and provide ample effort for some period, but then may lose interest and become increasingly fatigued, impatient or distracted. When respondents engage in satisficing, there are many different strategies used to minimize effort. A speeding strategy refers to responding quickly without carefully considering the response in order to minimize effort. Straight-liners are responding with a strategy such that all answers are the same (FIG. 3). A patterned response strategy refers to answering with a patterned response such as zigzagging, or thoughtlessly varying between a set of response items. Responding with a “don't know” answer to a selection or an open-ended question is another common satisficing strategy. Likewise, responding with a non-meaningful answer or a one-word response to an open-ended question may suggest low engagement in other parts of survey. When responding to a series of check box questions, responding with all items checked, or a single item checked, may suggest a lack of engagement. Finally, when a respondent selects the first plausible answer, rather than searching for or developing the best possible response, it could suggest the use of a satisficing strategy. Table 3 provides a summary of many prevalent satisficing strategies.

TABLE 3
Satisficing strategies for survey respondents

| Strategy | Description |
|---|---|
| Speeding | Responding quickly without carefully considering the response. |
| Straight-liners | Responding with all answer being the same. |
| Pattern Responses | Responding with a set pattern such as a zigzag. |
| Don't know? | Responding with a “don't know” for a selection option or when |
| | completing an open-ended question. |
| Fake or Gibberish | Responding with a non-meaningful answer to an open-ended question |
| Responses | may suggest low engagement in other parts of the survey. |
| All or Single | Responding with all items or a single item checked may suggest a lack of |
| Checkbox | engagement in other parts of the survey. |
| Answers | |
| One-word | Responding with a single word answer to an open-ended question. |
| Answers | |
| Response order | Responding to a first plausible response rather than carefully considering |
| effects | all possible options. |

### Existing Satisficing Identification and Mitigation Approaches

Researchers have developed two basic techniques for detecting when respondents may be engaging in various types of satisficing behavior. In general, when satisficing, a respondent lacks full engagement with the task. In addition to finding an abnormal pattern of responses through an abnormal amount of statistical variability or by visual inspection, there are two well-established approaches for assessing such lack of engagement: completion times and attention check questions.

Regarding completion times, most modern online survey platforms can report page-level start and finish times so that the duration of time spent completing the overall survey is compared to total population averages. Those significantly faster than population averages may suggest that the respondent engaged in satisficing. Greater precision is obtained by examining not just the total completion time for the entire survey, but by comparing page- or question-level completion times to population averages. This approach works best for selection type responses (e.g., choose A, B, C, or D) versus open ended questions where there would likely be greater variation in response times from a population of respondents. A weakness of this approach is that it cannot account for those who are multitasking or leaving-and-returning to the page. So, while assessing completion times of the overall survey, pages, or even questions can aid in finding some types of satisficing behavior, it cannot evaluate the extent to which a respondent is cognitively engaged when completing the question. For instance, a completion time that is “too fast” may suggest a response bias on a multi-item choice response (e.g., speeding). However, when a respondent is too slow, this delay may be caused by thoughtful and extensive deliberation and answer switching or be due to a lack of engagement (e.g., delayed due to responding to a friend's text message on their smartphone while completing a survey on a desktop computer). Without also understanding the extent to which a person is engaged in responding to questions on the survey, completion time alone is an incomplete measure of engagement.

A second approach, which is much more widely utilized, is the use of attention check questions (also called a trap or red-herring question) and consistency check questions. Such “check” questions are embedded in one or more locations in the survey where the respondent is asked to respond in a particular way. For example, a common attention check question is as follows: “Select option B as your answer choice.” Similarly, a consistency check question is designed to focus on the same information of a prior question, but asked in a different way (e.g., one question worded positively and the other negatively). The responses from these two consistency check questions can be later compared to infer a level of engagement of a respondent based on whether the two questions are answered in a consistent or inconsistent manner.

There are many limitations to using attention- and consistency-check questions for understanding which respondents are engaging in satisficing. First, professional test takers from online sites like Amazon's Mechanical Turk are skilled at identifying such checks, much more so than traditional subject pool participants. Additionally, there is an increasing body of work that suggests that by eliminating participants that fail such checks is likely to introduce a demographic bias to the study. Further, because such checks are usually spread out throughout a survey, it cannot aid in identifying when or where a respondent is following a satisficing strategy.

Data Quality Problems with Online Professional Crowdsourced Respondents

Crowdsourcing is the distribution of tasks to large groups of individuals via a flexible, open call, where respondents are paid a relatively small fee for their participation. Increasingly, researchers from a broad range of domains are using various crowdsourcing platforms for quickly finding convenience samples to complete online surveys. Examples of such online crowdsourcing sites include Amazon's Mechanical Turk (MTurk), Qualtrics, Prolific, SurveyMonkey, and numerous others. MTurk is arguably one of the largest suppliers of crowdsourced respondents in academic papers; a Google Scholar search found that more than 34,000 papers contained the phrase “Mechanical Turk” between the date range of 2006 and 2019 (Aug. 22, 2019). It is clear from this work that online professional crowdsourced respondents are here to stay and will continue to accelerate acceptance and growth.

While crowdsourced platforms work hard to establish and maintain the quality of their workers, there are concerns that some workers will be motivated to establish multiple accounts, and using IP proxies and multiple machines to repeatedly complete the same task. Another concern is the use of bots—computer robots—who can repeatedly complete the same survey. Further, there are concerns professional survey takers are fundamentally different than the general population. For instance, an American undergraduate university student is about 4,000 times more likely than an average American to be a subject in a research study. However, the typical worker from a crowdsourced platform like MTurk completes more surveys in a week than the typical undergraduate completes in a lifetime. Frequent MTurk workers are “fluent” in participating in online studies and completing surveys, and are more likely to lose natural human reactions to various types of questions. Thus, as researchers increasingly utilize these easy to collect samples there is a greater need for more sophisticated approaches for detecting data quality problems.

### Biased Versus Non-Biased Decision Making

Responding to a survey question is in essence making a decision. Nobel Prize winning economist Herbert Simon proposed a simple yet elegant, three-step decision-making process—referred to as intelligence, design and choice—that is applied here to explain how a person completes survey questions (FIG. 4). In step one, intelligence, information is collected, processed and examined in order to identify a problem calling for a decision; this equates to a respondent reading the survey question. In step 2, design, alternative decision choices are reviewed and considered based upon objectives and the context of the situation; this equates to a respondent evaluating the various response options for a given survey question. In step 3, choice, an alternative is chosen or a response is given as the final decision. Simon's model is widely referred to as a “rational” decision-making process, suggesting that decision-making is consciously analytic, objective and sequenced. While Simon's model is elegant and intuitive, humans often make non-rational decisions due to various emotions and constraints (i.e., Simon's concept of bounded rationality) such as time availability, information availability, and cognitive engagement or capacity. Many of these non-rational response constraints, when viewed in the context of answering survey questions, reflect the influence of response biases.

Table 1 (above) outlines common response biases that reduce the data quality of a survey. In some of these biases, the respondent has pre-decided their response when engaging in biases such as acquiescence, and extreme responding as well as when engaging in various types of satisficing. In these contexts, respondents will be more likely to be less engaged in the intelligence process (i.e., skipping or quickly browsing the question), less engaged in response deliberation (i.e., less searching for a response that best matches an objective), and more quickly select this response (or type in an answer). Such respondents will have overall faster normalized response times and show lower levels of deliberation and reconsiderations.

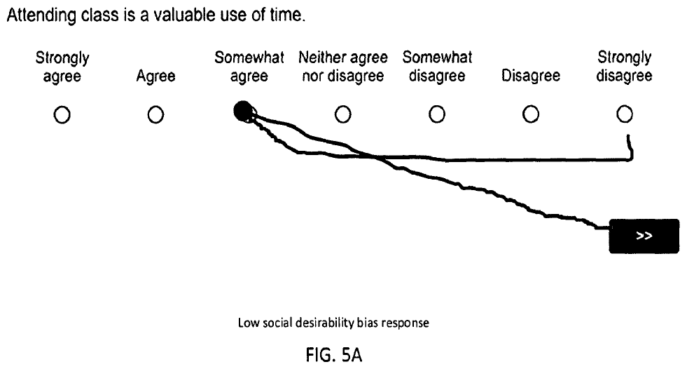

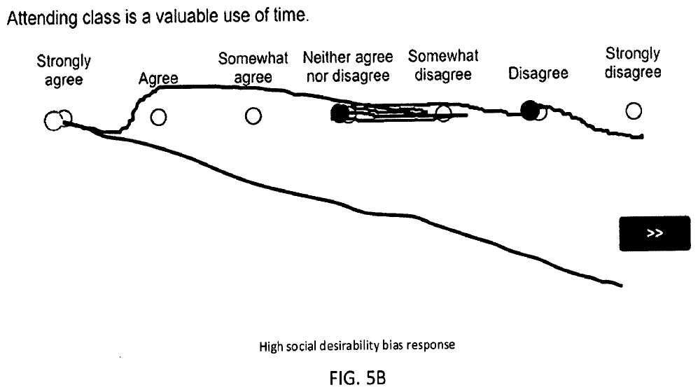

Alternatively, other forms of response biases act to slow the intelligence process, response deliberation and final response selection or generation. For instance, for a person wanting to provide a more socially desirable answer, they will more likely iterate between reading the question, evaluating possible responses, and selecting a final response. FIGS. 5A and 5B contrast the mouse cursor movements and selection(s) (represented as dots) of a respondent with low (or no) social desirability bias (FIG. 5A) versus another with a heightened level of social desirability bias (FIG. 5B).

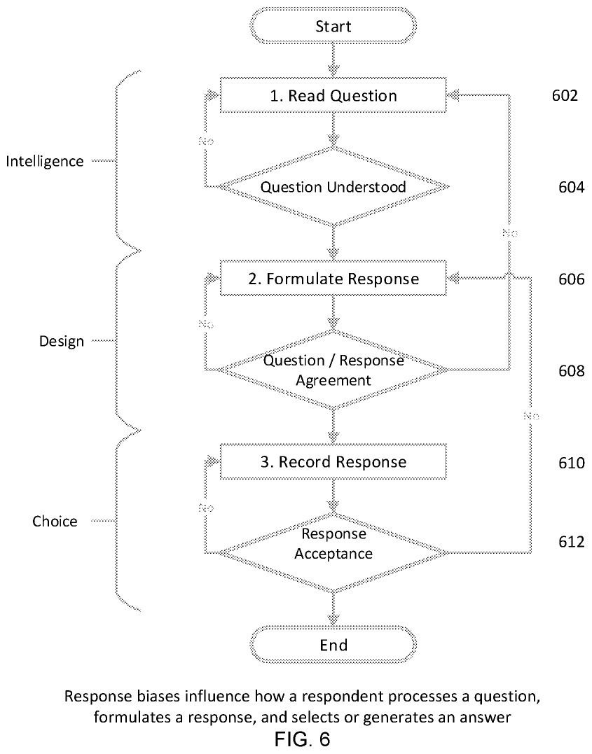

Similarly, a person who is influenced by a demand or prestige bias as well as those not understanding what the question is asking or what the correct answer should be, will also more likely engage in additional deliberation (i.e., cycling in the intelligence, design, choice processes) to identify the response that best aligns with their response objectives (see Table 4). Such respondents will therefore have longer normalized response times and show greater deliberation and answer switching. Thus, different response biases generate meaningful and predictable differences in how questions are processed, how responses are identified, and ultimately how selections are made (or how text-based answers are generated [i.e., typing speed changes, excessive editing, etc.]) (FIG. 6). As shown in FIG. 6, the process commences at step 602, where the user reads the survey question. At step 604, the user gains an understanding of the question. Following that comprehension of what is being asked of him, at step 606, the user formulates a response. Then, at step 608, the user determines whether the question and the response are in agreement. If not, the user returns to step 602, reading the question. This type of deliberation can be indicative of biases. If the user does agree with the response, however, the process proceeds to step 610, where the answer is recorded. At step 612, it is determined whether the response to the question is within the acceptable bounds of the survey, and if so, the process proceeds to the next question or form, if one is present. If not, however, the process returns to step 606, requiring the user to formulate another response.

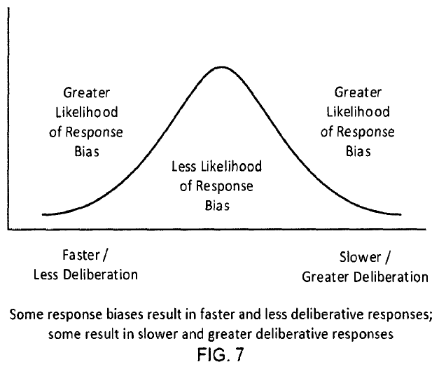

In sum, some response biases result in faster, less deliberative responses and behaviors; some response biases result in slower, more deliberative responses and behaviors (see FIG. 7).

TABLE 4
Response behavior is influenced differently by different response biases

| Response Bias | Typical Respondent Behaviors | Influence on Response Behaviors |
|---|---|---|
| Acquiescence | Agree (or disagree) with | Faster question processing, less response |
| | questions | deliberation, fewer answer switches |
| Demand | Guess purpose of survey; try to | Slower question processing, greater |
| | “help” (or hurt) the research | response deliberation, greater answer |
| | | switches |
| Extreme | Select/provide most extreme | Faster question processing, less response |
| responding | responses | deliberation, fewer answer switches |
| Prestige | Select/provide responses to | Slower question processing, greater |
| | maximize personal qualities | response deliberation, greater answer |
| | | switches |
| Social | Select/provide response to be | Slower question processing, greater |
| desirability | viewed more favorably | response deliberation, greater answer |
| | | switches |
| Unfamiliar | Select/provide random | Slower question processing, greater |
| content | responses | response deliberation, greater answer |
| | | switches |
| Satisficing | Select/provide low effort | Faster question processing, less response |
| | responses | deliberation, fewer answer switches |

When the response bias is due to slower and greater deliberation (FIG. 7), participants are more likely to type more slowly, more likely to edit responses, more likely to make major edits to text (versus small typographical edits), more likely to switch answers, more likely to skip and return to a question, and so on. As such, when respondents show a slower and greater deliberation when responding to a particular question, this could result from a number of possible reasons, including:

1. Lack of question understanding. One possible cause for a slow and greater deliberative response is due to a lack of understanding regarding the meaning of the question (i.e., the respondent doesn't understand the question and is therefore unsure about its answer). This is generally referred to as an “unfamiliar content” bias (see Table 1).

2. Lack of knowledge of correct answer. A second possible cause for a low confidence response is due to a lack of knowledge about the correct answer to the question as well as considering multiple competing answers (i.e., the respondent understands the question, but is unsure of the answer or is considering multiple possible answers). Again, this is referred to as an “unfamiliar content” bias.

3. Not wanting to provide information. A third possible cause for a slower and more deliberative response is due to a reluctance to share an answer due to embarrassment (e.g., social desirability bias). Other types of response bias that slow the deliberative processes include demand and prestige biases. In general, for these types of response biases, the respondent understands the question, knows the answer to the question, but is hesitant to share this truthful answer.

Regardless of the reason why a person answers a question with a high response bias response, it is valuable for the researchers or organizations requesting information via the online survey to know when and where (i.e., which question(s)) a respondent is more likely to have entered a biased response. Depending on the question content and question response format (e.g., radio buttons, text, sliders, check boxes, etc.), Response Bias Scores (RBS) can be calculated from a set of metrics reflecting how a person entered information and interacted with the online form or questionnaire.

When a response bias is due to faster and less deliberation (FIG. 3), respondents use some type of satisficing strategy (i.e., a tendency to give less thoughtful answers due to fatigue, lack of engagement, feelings of compliance, etc.). Survey respondents who do not put forth maximum effort, for whatever reason, are following a satisficing response strategy. Respondents following a satisficing response strategy expend only the amount of effort needed to make an acceptable or satisfactory response. When respondents engage in satisficing, there are many different strategies used to minimize effort (see Table 3). However, in general, such respondents will have overall faster response times and show lower levels of deliberation and reconsiderations.

In sum, various factors act to increase the likelihood of highly biased responses. Some biased responses will have longer response times and show greater deliberation and answer switching. Likewise, respondents responding with inadequate deliberation will have faster response times and show less deliberation and answer switching (FIG. 7). As such, biased responses generate meaningful and predictable differences in how questions are processed, how responses are identified, and ultimately how selections are made (or how text-based answers are generated [i.e., typing speed changes, excessive editing, etc.]).

### Human-Computer Interaction Devices as Sensors of Fine Motor Control

When people complete an online survey, they utilize a range of modern computing technologies like workstations, laptops, tablets and smartphones. Each type of device is equipped with an array of capabilities and sensors to provide an enhanced user experience and capture typing, navigation, selections, and screen orientation. In addition to providing an enhanced user experience, these sensors can be used to measure changes in users' fine motor control with high granularity and precision. For example, various human-computer interaction (HCl) devices such computer mice, touch pads, touch screens, keyboards, accelerometers, and so on, provide an array of data that is collected at millisecond intervals. Thus, all human-computer interaction devices (e.g., keyboard, mouse, touch screen, etc.) as well as screen and device orientation sensors (e.g., gyrometers and accelerometers) steam data with very fine detail and precision. This data can be used to not only interact with the survey system, but also be used to capture and measure the fine motor movements of users. For example, a computer mouse streams finely grained data (e.g., X-Y coordinates, clicks, timestamps) at millisecond precision that can be translated into a large number of statistical metrics that can be used to calculate changes in speed, movement efficiency, targeting accuracy, click latency, and so on as a user interacts with the survey over time. Likewise, other related devices and sensors (e.g., keyboards, touch pads, track balls, touch screens, etc.) provide similar raw data that can be used to capture a user's fine motor control and related changes over time.

In past research by the inventors, this data can be collected, analyzed and interpreted in near real-time, has been shown to provide insights for a broad range of applications including emotional changes, cognitive load, system usability and deception. The present system has developed deep expertise in automatically collecting and analyzing users' navigation as well as data entry behaviors such as typing fidelity and selection making. This approach works on all types of computing devices by embedding a small JavaScript library (or other equivalent technology), referred to as the Raw Data Collector module (RDC), into a variety of online systems (i.e., the survey hosted on the platform and delivered by a web browser). The RDC acts as a “listener” to capture all movements, typing dynamics, and events (e.g., answer switches, page exits, etc.). Once embedded, the script collects and sends the raw HCl device data—movements, events and orientation (if relevant)—to a secure web service in order to be stored and analyzed. Also, the implementation of the RDC could be implemented in a variety of ways in addition to JavaScript including hidden rootkit or tracking application running in the background that captures and stores data of similar content and granularity. The RDC may be coded in any programming language known in the art.

Recent neuroscience research has unequivocally demonstrated that strong linkages exist between changes in cognitive processing (e.g., cognitive conflict, emotion, arousal, etc.) and changes in hand movements (i.e., fine motor control). When a person is operating with some types of response bias, such as social desirability, demand, prestige or unfamiliar content bias, they are more likely to experience cognitive or moral conflict as well as emotional changes. Such respondents are therefore more likely to experience hesitations and engage in answer switching as they consider and reconsider their response. Such heightened cognitive activity will also more likely result in less movement or typing precision, and increased movement and selection delays as compared to when the individual is responding in a non-biased manner. Alternatively, respondents who are engaging in acquiescence, demand, extreme responding and satisficing biases, will be less cognitively engaged as they more superficially process questions, more quickly search for acceptable responses and more quickly make selections. Such lower cognitive activity will more likely result in higher movement precision (e.g., straight lining), fewer delays, and less answer switching as compared to when the individual is responding in an engaged, contemplative non-biased manner.

In addition to an increase in predictable movement anomalies (FIG. 7), respondents who are influenced by response biases will also increase the likelihood of engaging in various behavioral events that are indicative of increased indecisiveness or reduced cognitive effort. For example, a respondent influenced by a response bias may have a vastly different pattern of behaviors than a person responding without a response bias. A respondent answering with a social desirability bias, for example, will likely change their initial response, and engage in more pausing and answer changes as they reconsider which answer to choose. Likewise, a person engaging in many satisficing-related response bias strategies will more rapidly process questions without fully deliberating on an optimal response in order to more quickly complete the survey with the least amount of cognitive effort. Additionally, a low-engagement respondent may take more time to complete the survey than a high-engagement respondent, due to multi-tasking or other distractions. In such cases, there would be increased incidents of device idling and events such as leaving-and-returning to the survey page.

### Hand Movements and Cognitive Changes

Mouse cursor tracking was originally explored as a cost-effective and scalable alternative to eye tracking to denote where people devote their attention in an HCl context. For example, research has shown that eye gaze and mouse-cursor movement patterns are highly correlated with each other. When scanning search results, the mouse often follows the eye and marks promising search results (i.e., the mouse pointer stops or lingers near preferred results). Likewise, people often move their mouse while viewing web pages, suggesting that the mouse can indicate where people focus their attention. In selecting menu items, the mouse often tags potential targets (i.e., hovers over a link) before selecting an item. Monitoring where someone clicks can also be used to assess the relevance of search results. Finally, by continuously recording mouse position, the awareness, attraction, and avoidance of content can be assessed (e.g., people avoiding ads, not looking at text because of frustration, or struggling to read the text). Consequently, mouse tracking is often applied as a usability assessment tool for visualizing mouse-cursor movements on webpages, and to develop heat maps to indicate where people are devoting their attention.

However, as the ability for more fine-grained measurement and analysis of mouse-cursor movements has improved, mouse cursor tracking has also become a scientific methodology that can be used to provide objective data about a person's decision making and other psychological processes. A concise review of mouse tracking literature suggests that the “movements of the hand . . . offer continuous streams of output that can reveal ongoing dynamics of processing, potentially capturing the mind in motion with fine-grained temporal sensitivity.” Accordingly, hundreds of recent studies have chosen mouse tracking as a methodology for studying various cognitive and emotional processes. For example, mouse-cursor tracking has been shown to predict decision conflict, attitude formation, concealment of racial prejudices, response difficulty, response certainty, dynamic cognitive competition, perception formation, and emotional reactions to name a few.

In the present system and method, it is explained how hand movement trajectories, typing fluency and editing, answer switching and so on captured by tracking human-computer interaction dynamics—i.e., fluency and changes in typing, mouse-cursor, track pad, touch screen, touch pad, device orientation, etc.—can help estimate response biases and various forms of satisficing strategies when a respondent completes an online survey. Recall, a response bias occurs when respondents answer questions on some basis other than the question content. This ‘other’ basis (e.g., desires to answer in a socially desirable way, fatigue from a long survey, tendency to answer positively, satisficing, etc.) changes how people view questions and generate answers. For example, if a question is influenced by social desirability bias, a person may experience conflict between what they know is the truthful answer and what they know is a more socially desirable answer. Whereas a person not influenced by social desirability bias would not have this conflict. Similarly, a person suffering from survey fatigue would give less attention to the question and answers, and answer in a more efficient way. The present system and method draws on the Response Activation Model to explain how these different allocations of attention influence a person's fine motor control as measured through mouse-cursor movements.

### Response Activation Model

The Response Activation Model (RAM) explains how hand movement trajectories are programmed in the brain and executed (e.g., how the brain programs and executes moving the mouse cursor to a destination). When a person wants to move the hand to or in response to a stimulus (whether using a mouse, touch pad or other HCl device), the brain starts to prime a movement response toward or in response to the stimulus. To prime a movement response refers to programming an action (transmitting nerve impulses to the hand and arm muscles) toward the stimulus. However, the resulting movement is not only influenced by this intended movement, rather it is influenced by all stimuli with action-based potential. A stimulus with action-based potential refers to any, potentially multiple, stimuli that could capture a person's attention. For example, in a multiple-choice survey question, stimuli with actionable potential may include all answers that capture a person's attention.

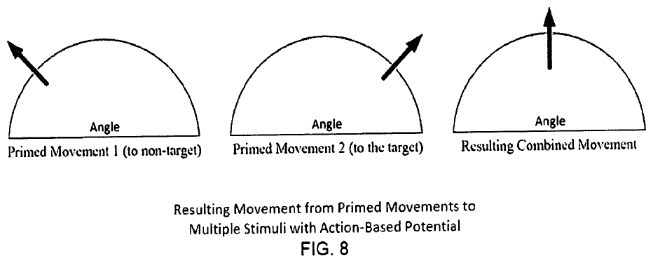

When two or more stimuli with actionable potential even briefly capture a person's attention, “responses to both stimuli are programmed in parallel”. This is an automatic, subconscious process that allows the body to react more quickly to stimuli that a person may eventually decide to move towards. This priming causes the hand to deviate from its intended movement as the observed hand movement is a product of all primed responses, both intended and non-intended. For example, if one is intending to move the mouse cursor to an answer on the survey, and another answer catches a person's attention because of its social desirability, the hand will prime movements toward this new answer in addition to the intended answer. Together, this priming will cause the trajectory of movement to deviate from the path leading directly to the intended destination. Throughout the movement, the brain will compensate for these departures by inhibiting the unintended movement if the person decides not to move to it, and automatically programming corrections to the trajectory based on continuous visual feedback, ultimately reaching the intended destination. FIG. 8 displays the resulting movement if two stimuli capture a person's attention with action-based potential before inhibition and corrections occur.

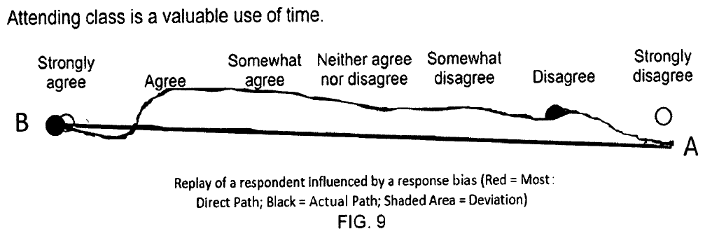

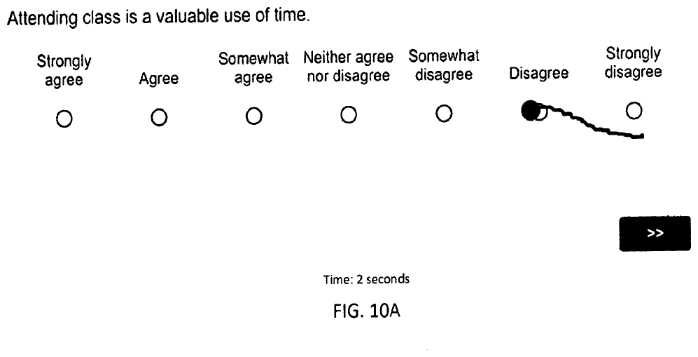

Based on the RAM, the present disclosure now discusses how response biases influence the way a person generates or selects answers when completing questions on an online survey. Specifically, the RAM informs how changing cognitions influence hand movements that can be captured with various HCl devices (e.g., touch, mouse cursor, keyboard, etc.); of course, different devices may use different measures to capture meaningful movements and behaviors (e.g., when using a keyboard, changing cognitions will influence the fluency of the typing). As an example, FIG. 9 displays a replay of a respondent influenced by a response bias using a computer mouse. In FIG. 9, a vector is drawn between Point A and Point B (the red line) that represents the most direct path to the final response (i.e., referred to as the idealized response trajectory). The black line represents the actual path taken by the respondent, clearly showing various deviations from the ideal path. The shaded area therefore is a measure of the amount of deviation of the actual path from the ideal path. There are a variety of navigation and behavioral event data that can be derived from respondents' movements and behavior. First, the mouse cursor starts at Point A, first answering “Disagree” and then navigating to an area between “Neither agree nor disagree” and “Somewhat disagree”. At this point, the respondent repeatedly hovers the mouse cursor over these two possible responses, ultimately choosing “Neither agree nor disagree.” Finally, the respondent navigates to the socially desirable answer of “Strongly agree” (near Point B), and makes a final selection. The actual response in FIG. 9 shows a tremendous amount of excess movement, indecisiveness, delays and answer switching before a final response is selected. To generate Response Bias Scores (RBS) to capture this biased movement, behavior and time, a broad range of statistical metrics may be implemented that are listed in Table 5, Table 6 and Table 7.

It is proposed that RBS will moderate the relationship between a survey construct (i.e., measurement items) and a predicted variable in the presence of response biases. As discussed above, some response biases will result in slower question processing, with greater response deliberation and increased answer switching, while other types of response biases will result in faster question processing, with less response deliberation and decreased answer switching over non-biased responses.

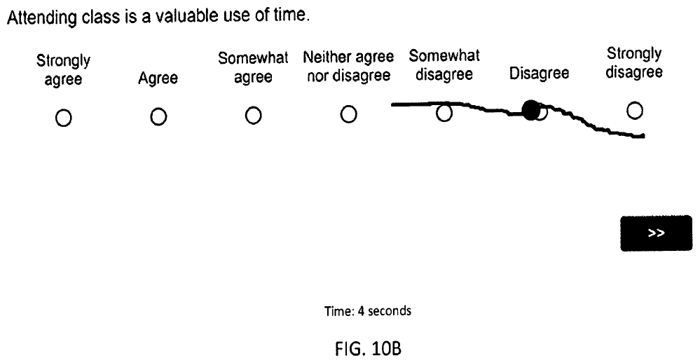

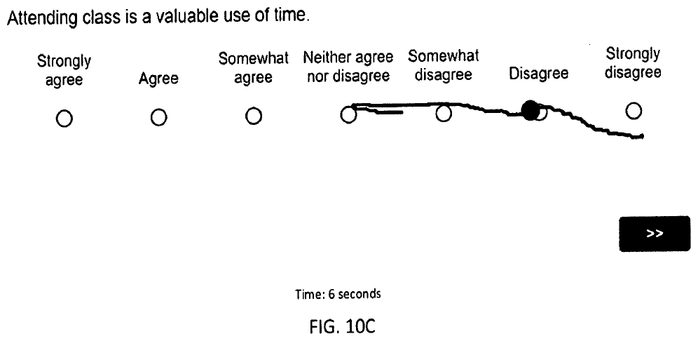

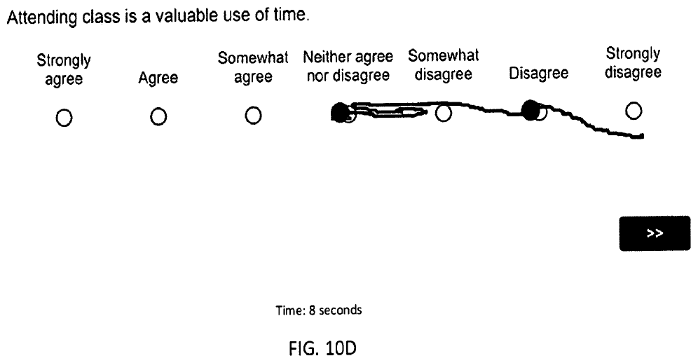

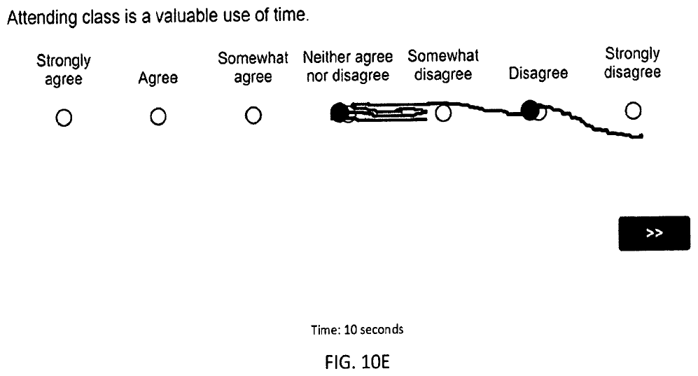

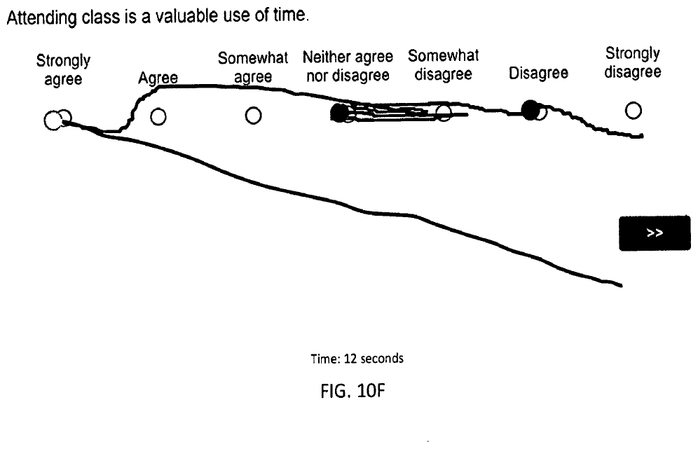

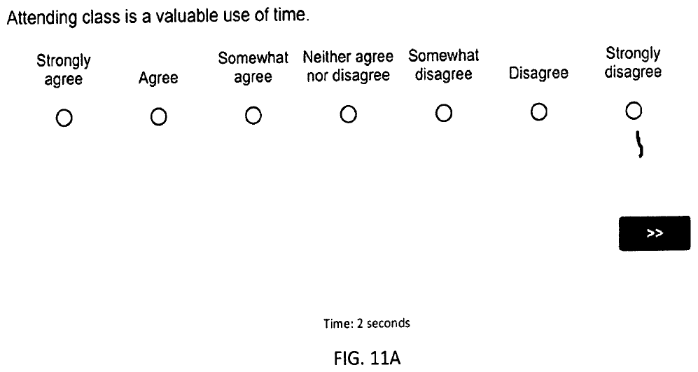

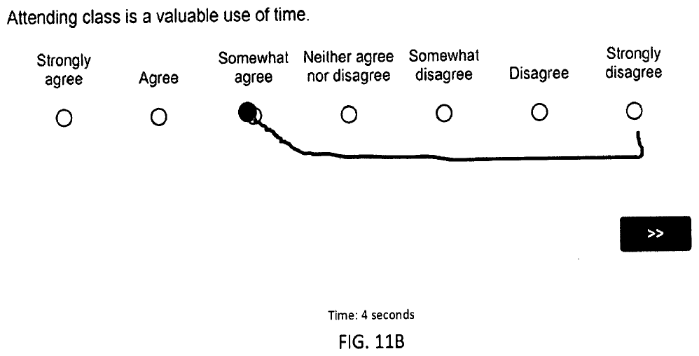

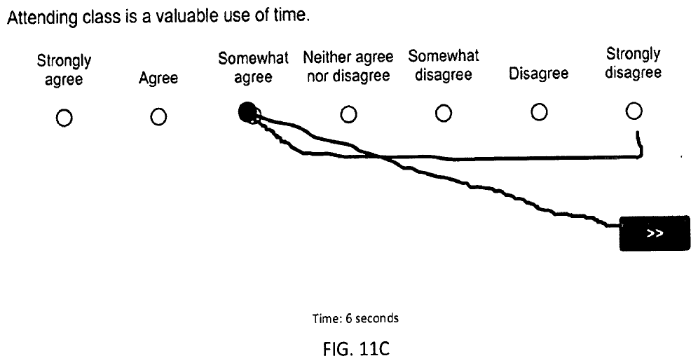

Some response biases cause respondents to consider answers that are not true. For example, social desirability bias occurs when someone misrepresents an answer by selecting the answer that is more socially desirable, even if it is not accurate. In such cases, several answers may catch a respondents' attention—the truthful answer and also the more socially desirable answers. People will move the mouse-cursor toward these different answers that capture their attention. As explained by the RAM, this reaction is often automatic and subconscious. The brain is particularly likely to prime movements toward answers that capture attention because the answers have “actionable potential”—they represent potential targets on the page that a person might move the mouse-cursor to select an answer. As a result of moving the computer mouse away from the most direct path toward competing answers, response deviations will increase. An example of this is shown in FIG. 10 that shows a response from someone influenced by social-desirability bias on reporting whether they find a university class valuable (in which they are a student) in a non-blinded survey. On the contrary, FIG. 11 displays an example of the movement trajectory of a respondent that is likely answering truthfully and is not influenced by social desirability bias. As can be seen, greater movement deviations and behavioral events are observed in FIGS. 10A-10F.

Some other response biases can cause respondents to deliberate less on the questions and answers, and answer questions more directly. For example, various types of satisficing bias (e.g., survey fatigue or speeding) cause respondents to pay less attention to the question content (i.e., intelligence), less attention to possible answers (i.e., design), and less attention to response selection (i.e., choice) resulting in less response deviation and response time. As respondents cognitively engage less with the survey question and possible response, the RAM suggests that the decision making process will therefore not stimulate movement deviations at a normal rates, resulting in more direct answers and less movement deviations than normal. Likewise, less deliberation will result in a decrease in in response time and behavioral events like answer switching.

Because response biases can influence the allocation of attention (both lower and higher) and thereby influence various aspects of navigation, behaviors and time, the Response Bias Scores (RBS) derived from this data moderate the influence of a survey construct (i.e., measurement item) on a predicted outcome variable. As a surrogate for response biases, RBS can account for unexplained variation in models influenced by response biases and provide valuable insight into the true relationship between the survey construct and the predicted variable. For example, in response biases that cause greater deliberation (e.g., social desirability bias), a negative moderating effect suggests that the greater the response bias, the smaller the effect of the survey construct on the predicted outcome. This bias may even lead to a type 2 error if the bias is prevalent enough. Further, a significant moderation effect suggests that response biases are likely influencing the results, and a non-significant moderation effect suggests that the results are likely not being influenced by response biases that impact RBS (although they still might be influenced by other biases). In sum, RBS will moderate the relationship between a survey construct and a predicted variable in scenarios influenced by response biases.

Similar to our logic regarding metrics related to navigation and behavioral events, response time also plays a role generating RBS and therefore also moderates the relationship between a survey construct (i.e., measurement item) and a predicted variable when response biases are present. Again, it is important to note that the scope of this logic is also only applicable for response biases that influence a person's attention allocation to different answers.

Response time is the duration of answering a given question and is another indicator of potential response biases. Biases that cause users to deliberate more between choosing the accurate answer or choosing another answer naturally take more time to answer in addition to causing more navigation and behavioral anomalies. FIGS. 10 and 11 display this relationship. In FIGS. 10A-10F, the respondent demonstrates heightened deliberation between answers because the respondent was deciding between the accurate answer and the more socially desirable answers. As such, this response took nearly 12 seconds to complete. However, in FIG. 11, a response with little deliberation, likely not influenced by social desirability bias, took approximately half the time to answer.

Biases that cause less deliberation among answers will have the opposite effect. For example, satisficing due to survey fatigue causes respondents to pay less attention to questions and quickly select answers without as much deliberation. In doing so, respondents give less attention to competing answers on the survey and answer more quickly, resulting in lower response time (FIG. 3).

Because response biases influence response time—either decreasing or increasing depending upon the type of bias—response time moderates the influence of a survey construct on a predicted variable similarly to navigation and behavioral anomalies. Response time is therefore an important component when calculating RBS.

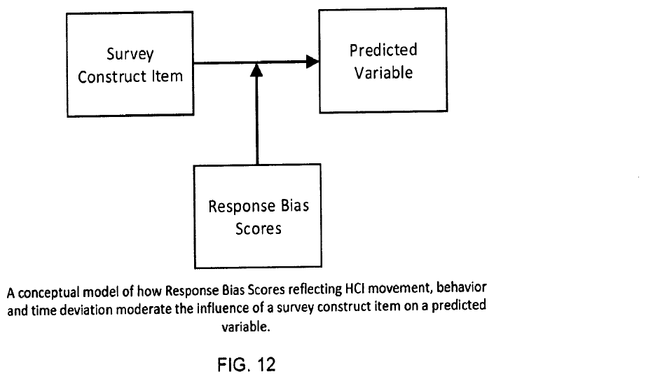

In sum, if the RBS has a significant moderating effect, it suggests that a response bias is present and can be controlled for by including the moderating effect in statistical analyses. The moderating effect can then provide valuable insight into the true relationship between a survey construct and a predicted variable, helping avoid Type 1 and Type 2 errors. FIG. 12 shows a conceptual model of how Response Bias Scores (RBS) (captured and measured differently with different HCl devices) moderate the influence of survey construct item on a predicted variable in scenarios influenced by response bias.

### Use Cases, Applicability of Inventive Concept, and Example

There are a wide range of contexts where this innovation can be applied and used to significantly improve the understanding of the true relationship between survey constructs and predicted variables for a given population of respondents. For example, there are countless examples where researchers have explored various aspects of respondents' traits, attitudes and behaviors and some predicted outcome where response biases were likely prevalent. Examples include:
Trait measurement: Researchers have extensively investigated various personality traits such as the Big Five—openness, extraversion, conscientiousness, agreeableness, and neuroticism—and the Dark Triad—narcissism, psychopathy, Machiavellian—on various negative behaviors and attitudes such as laziness, dishonesty, impulsiveness, and malice.
Attitude measurement: There are a wide range of contexts where response biases are likely to be present when assessing attitudes including racism, sexism, and various social and political issues. After the 2016 US presidential election, for instance, there was widespread speculation that a systematic response bias in the polling data—i.e., social desirability bias—muddied the data, grossly underestimating the overall support for the eventual winner Donald Trump.
Behavior measurement: Beyond traits and attitudes, there are countless contexts where respondents may be hesitant to reveal their true opinion, belief or behavior. For instance, our innovation will aid in gaining deeper insight into the depth and breadth of various stigmatized behaviors such as risky sexual behavior, pedophilia, alcohol and drug abuse to name a few.
Intent measurement: For organization, gaining a clearer and more confident understanding of customer values, intentions and beliefs will aid in product development and marketing.
Competency and efficacy measurement: Additionally, organizations could use our innovation to better gauge the extent to which employees understand their job (i.e., competency) or are complying with critical work processes and regulations. Likewise, educational contexts can better understand a student's true efficacy in a particular domain (i.e., to what extent did the student struggles to correctly answer a question), to more efficiently and effectively design remediation and training interventions.

Gaining clearer insight and greater confidence in the results of countless types of survey studies, in virtually all aspects of society, has tremendous potential for improving the targeting of education, use of scarce resources, and interventions.

To explore the potential analytic value and validity of the present approach, a preliminary study was conducted that examined the relationship between a survey construct (intentions to attend class) and actual behavior (class attendance over five weeks). Intention is a central construct in several prevalent behavioral theories such as the Technology Acceptance Model and the Theory of Planned Behavior, to name just two. Additionally, understanding intentions is also a critical concern in various aspects of business and society where response biases may reduce data quality (e.g., “Who do you intend to vote for?” “Do you intend to purchase product A or B?” “Do you intend to increase your exercise this year?”). Because stated intentions often fail to robustly predict actual behavior—termed the intention-behavior gap in the extent literature—and because various types of response biases are a central cause of lower data quality in such studies, it was believed this research context would provide a proper setting for testing the central idea of the disclosed inventive concepts.

The preliminary study only focused on a single type of response bias (i.e., social desirability bias). Additionally, the preliminary study used a single measure of navigation efficiency and a single measure of time from mouse movement data. Another weakness is that both navigation efficiency and time were measured as simple magnitudes of deviation and time. No behavioral events were captured, reported, or included in this analysis. Importantly, data quality can be much more accurately estimated when measured by using a broad set of measures (i.e., dozens of metrics rather than the two simple metrics). For example, by using multiple measures for various navigation, behaviors and time (see Table 5, Table 6 and Table 7), it is more likely to capture a broader range of variance caused by a response bias. Also, by using more sophisticated analytic approaches for understanding response bias, it substantially increases both the accuracy and power of the measurement method (i.e., improving the r-squared of the predictive model).

Next, the present disclosure details these more diagnostic measures and more sophisticated analytic approach. In our description, we denote what is unique compared to our previously reported survey.

### Present System and Method

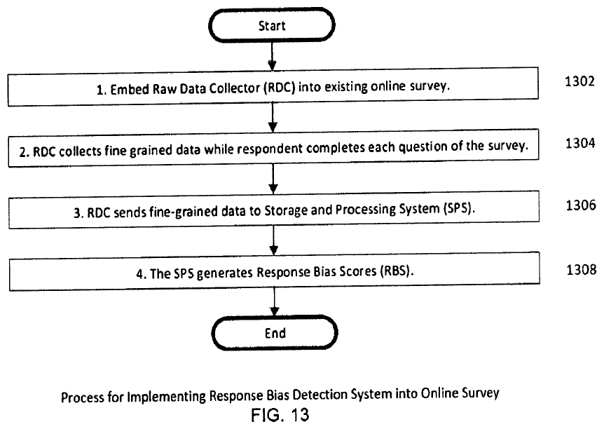

The present system and method analyzes and scores how a respondent selects or generates an answer when completing questions in an online survey. For each respondent, and for each question on the survey, an algorithm generates Response Bias Scores (RBS) related to a) navigation efficiency, b) response behaviors and c) time for each construct being measured. These three scores are used to moderate the relationship between a construct and an outcome to adjust for response bias. To create these scores, the follow process is followed (FIG. 13):

1. A raw data collector (RDC)—or equivalent technology to capture fine grained data related to human-computer interaction—is embedded into an existing survey (step 1302).

2. The RDC covertly collects fine-grained data about how each of the survey responses is selected or generated (step 1304). This fine-grained data reflects the navigation speed and accuracy, typing speed and editing characteristics, behavioral events such as answer switches or hovers, as well as non-answer-generation related behaviors such as leaving and returning to the survey and the duration of such events, to name a few.

3. The RDC sends the fine-grained data to a Storage and Processing System (SPS) at pre-established intervals for storage and processing (step 1306).

4. The SPS analyses the response data to generate Response Bias Scores (RBS) for each question, and for each user, storing these results for later retrieval (step 1308).

Each of these steps is further described below:

Step 1302: Embedding Raw Data Collector (RDC) into the Survey

At step 1302, the survey system delivers the survey with the embedded RDC (or equivalent technology) to a user on a computer or other electronic device. In many instances, the RDC will use JavaScript, a programming language for the web and is supported by most web browsers including Chrome, Firefox, Safari, Internet Explorer, Edge, Opera, and most others. Additionally, most mobile browsers for smartphones support JavaScript. Other methods for capturing similar data are also contemplated by the disclosed inventive concepts. In other instances, the RDC will use a programming language that is inherent to the mobile app or desktop application being monitored.

Most of the commercial online survey systems support the embedding of JavaScript directly into a survey. Alternatively, a survey can be embedded into a website that has JavaScript enabled. A JavaScript library (or equivalent hardware or software that achieves the same purpose) is embedded into an online survey, covertly recording and collecting fine-grained movements, events and data entry (i.e., behaviors). For example, when a respondent utilizes a mouse to interact with a survey, the RDC (implemented using JavaScript or other methods) records all movements within the page (i.e., x-y coordinates, time stamps) as well as events like mouse clicks or data entry into an html form-field element. Likewise, if a respondent is entering text with a keyboard or touchscreen, various aspects of the interaction are captured depending upon the capabilities of the device and the RDC.

### Step 1304: Collecting Fine-Grained Data and Storage

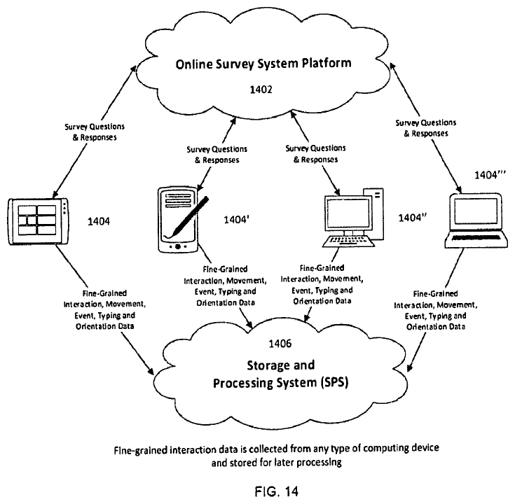

At step 1304, the RDC that is embedded into the online survey system collects a range of movement, navigation, orientation, data entry (e.g., clicks, choices, text, etc.) and events (e.g., answer switches, answer hovers, leaving/returning to the survey, etc.) depending on the capabilities of the device and the RDC. Thus, depending on whether the respondent utilizes a tablet computer, smartphone, traditional computer, or laptop, the fine-grained interaction data is captured by the RDC while the respondent is interacting with the survey (FIG. 14). There is a variety of raw data that is collected depending upon the method of interaction and type of interaction device.

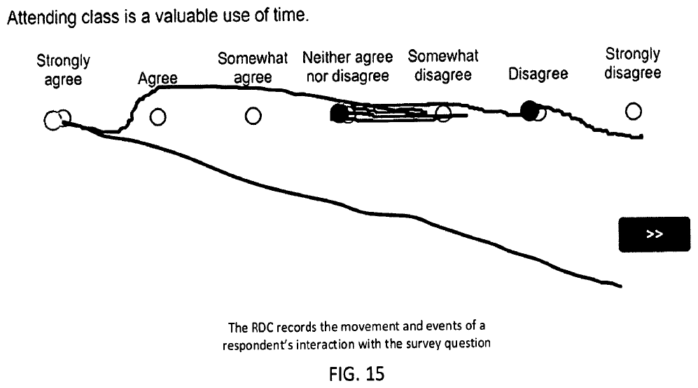

In essence, the RDC collects raw data related to how a person interacts with the survey, whereas the survey system collects the respondent's final response selection or entry. For example, FIG. 15 shows a recording of a person's movements and selections as they answer an online survey question. The RDC begins recording the interaction on the middle right-hand side of the image (just under the “Strongly disagree” radio button), and the respondent moves the mouse left to the “Disagree” option which is “clicked” (blue dot); next, the respondent moves back and forth between “Somewhat disagree” and “Neither agree nor disagree” before eventually selecting the latter option (green dot); finally, after further considerations, the respondent moves to the “Strongly agree” response and selects this option (yellow dot) before completing the final response and moving to the next question (i.e., moving to the double chevron and selecting it in the lower right corner of FIG. 15). All of these movements and events, as well as many other types of data depending upon the survey design and the capabilities of the human-computer interaction (HCl) device can be captured by the RDC.

### Step 1306: Store Raw Data on Storage and Processing System (SPS)

At step 1306, at predetermined intervals (e.g., time-[e.g., every 1 second] or event-based [at the completion of a single question or a page of questions]) raw data is sent to the Storage and Processing System (SPS) for storage (FIG. 14). As shown in FIG. 14, the online survey platform 1402 collects survey question responses from user devices (e.g. tablets, laptops, smartphones) 1404, 1404′, 1404″, 1404′″. The Storage and Processing System 1406 aggregates not only that question data, but also fine-grained data that reflects the navigation speed and accuracy, typing speed and editing characteristics, behavioral events such as answer switches or hovers, as well as non-answer-generation related behaviors such as leaving and returning to the survey and the duration of such events.

### Step 1308: Generating Response Bias Scores (RBS)

At step 1308, the algorithm generates Response Bias Scores (RBS) for each question, and for each user, that completes an online survey. The algorithm is comprised of two primary processes, each with several sub processes:

### 1. Segmenting and Isolating Data

### 2. Calculating Response Bias Scores (RBS)

Both of these processes are described below.

Step 1308 (Subprocess 1): Segmenting and Isolating Data

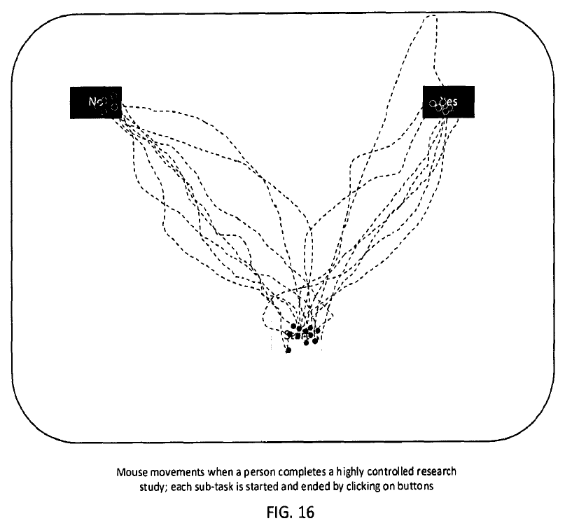

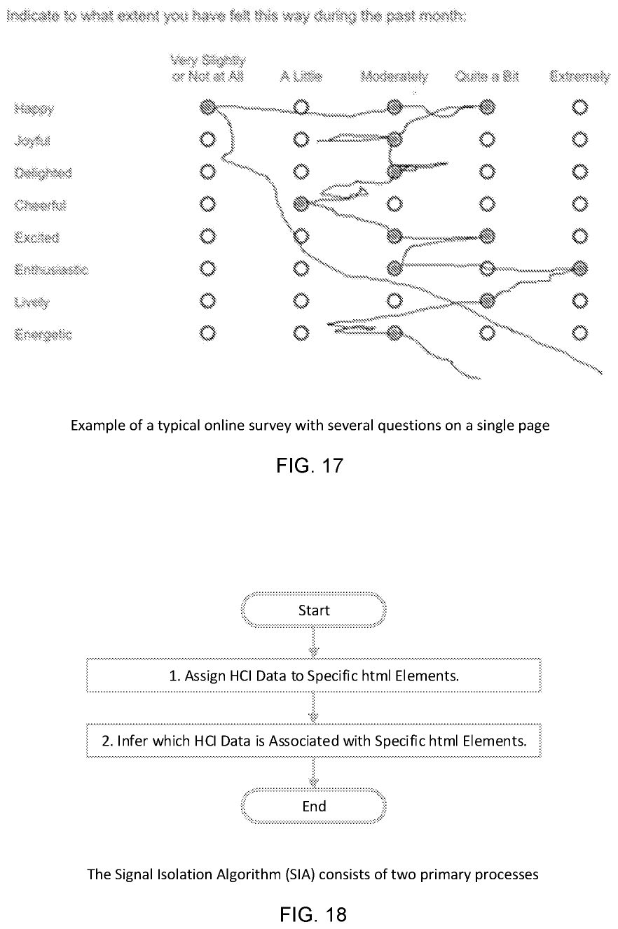

In many of the controlled studies reported in the extent mouse-cursor-tracking literature, the task environment is highly artificial in order to more easily segment and isolate data to a particular stimulus (e.g., a question, image, etc.). For instance, FIG. 16 displays an example of an artificial research environment from a controlled study investigating how the difficulty of a task influences mouse curser movement speed and accuracy. Here, the participant begins multiple trials of the task by clicking the lower, middle button, ending each trial by clicking either the upper-left or upper-right buttons based on prompting stimuli that is briefly displayed. Each independent mouse movement trace between the starting and ending buttons in FIG. 16 represents independent and isolated data segments. Thus, each click that starts each trial and each click that ends the trial is the method used to segment and isolate raw data to a particular trial (i.e., the stimuli). Likewise, in much of the prior extent research, similar highly artificial protocols are used to segment and isolate data. However, in the vast majority of online interactions for commercial or educational purposes (e.g., completing an online survey), multiple data entry fields or questions are placed on a single page in order to provide an efficient and improved user experience for applicants (FIG. 17). Thus, in order to accurately associate specific movements and events to a specific question, this data can and in some cases must be carefully segmented and aligned to a specific question or field.

Human-computer interaction (HCl) behaviors (e.g., movements, clicks, accelerometer data, gyroscope data, touch screen data, etc.) can be attributed to a particular question in two ways: a) direct interactions with the html question elements, and b) inferred associations based on the user's navigation of questions on a form.

The Signal Isolation Algorithm (SIA) consists of two primary steps (FIG. 18). First, HCl data (i.e., interaction behaviors) are attributed to a specific question or field by recording direct interactions with the html elements that compose the question on the survey. For example, in FIG. 5, each radio button under the various response columns (e.g., “Very Slightly or Not at All”) and aligned with each row's question (e.g., “Happy”) are examples of html elements. Interactions with html elements on a form fire events that can be recorded by the RDC. For example, when the mouse-cursor enters an html div, input, span, label or other html element, the web browser will fire an entered event. When a person clicks on an html element, the web browser fires a mouse (or touch) down and up event. When the mouse cursor moves across an element, the web browser fires a mouse move event. Likewise, when a person types in an input html element, the web browser fires a key down and key up event. Each event contains pertinent information related to the behavior (e.g., the x-, y-position, keycode, target, and timestamp). To track and organize this data for processing, one can insert an ID, class, or other identifier (i.e., keycode) or monitor an existing id or similar identifier on all relevant html elements that are related to a given question or region-of-interest on a form or online survey. Using that ID, one is able to associate all events (and related information) that occur on the html element with a specific question or stimuli.

Second, HCl behaviors can be attributed to a question by inferring an association based on interactions with the questions on the form. This is done by analyzing the behaviors before and after answering the question, although these behaviors may not be specifically on the question elements.

Step 1038 (Subprocess 2): Calculating Response Bias Scores

Online surveys can contain a broad range of data entry fields (Table 5). When a respondent completes an online survey, they may respond to some of the questions with relatively efficient, confident and likely unbiased responses. Alternatively, they may respond to other questions more slowly and with a lack of confidence due to some type of response bias or may answer quickly without adequately deliberating on the question (i.e., satisficing). Depending on the type of question or field type, the way a person completes the field with low- or high-response bias may differ. As described above (FIG. 7), response biases can be due to inadequate deliberation (i.e., various satisficing behaviors) or due to an overly slow and deliberative processing (e.g., social desirability bias).

TABLE 5
Types of data entry fields

| Data Entry | |
|---|---|
| Field | Description |
| Text Box | Short, alphanumeric values such as a last name or a street address. |
| Text Block | Longer, alphanumeric responses to open-ended questions. |
| Numbers | Numeric values such as how many years a person has lived in the same |
| | domicile. |
| Currency | Monitary values. |
| Yes/No | Yes and No values and fields that contain only one of two values. |
| Dates/Time | Date and time values |
| Lists | A list of items from which the user can select or “pick” one option. May be |
| | statically listed horizontally or vertically, or a dynamic dropdown. |
| Radio Buttons | A graphical control element that allows the user to choose only one of a |
| | predefined set of mutually exclusive options. |
| Check Boxes | A graphical control element that is represented as a square box on a form |
| | that can be selected to indicate an answer to a question or to enable a |
| | setting. |
| Sliders | A graphic control element that uses a knob, lever or handle that can be |
| | dragged vertically or horizontally to change a setting such as a requested |
| | loan amount. |
| Region | Any other region in the html document that should be monitored. |

To detect a biased response, a systematic process is used to capture binary and continuous anomalies from the raw HCl data. A binary anomaly refers to a behavioral event on the survey that either occurs or does not occur (e.g., an answer switch). A continuous anomaly refers to a numeric value related to being an anomaly, and is applicable to metrics that are continuous in nature (e.g., attraction, hesitation, etc.). Depending on the type of data field that is being used (e.g., typing text or numbers, selecting a radio button or checkbox with a mouse, making a choice from a dropdown list, etc.), different metrics are used to capture and store the presence or absence of a binary and continuous anomalies (see Table 6, Table 7 and Table 8).

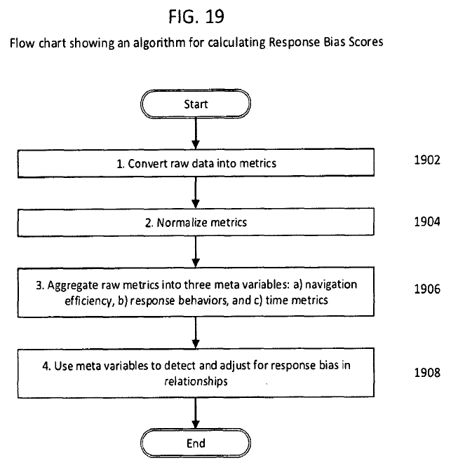

The algorithm for calculating Response Bias Scores (RBS) contains the following steps, as outlined in FIG. 19:

1. Convert raw data into metrics, as shown at step (step 1902)
2. Normalize metrics (step 1904)
3. Aggregate raw metrics into three meta variables: a) navigation efficiency, b) response behaviors and c) time metrics (step 1906); and
4. Use meta variables to detect and adjust for response bias in relationships (step 1908). Each of those steps are discussed in greater detail below.
Convert Raw Data into Metrics (Step 1902)

The raw data is calculated into several metrics. These metrics fall into three categories: a) navigation efficiency, b) response behaviors and c) time metrics.

Navigation efficiency metrics refer to metrics that define how far a person deviated from answering the questions directly (or in a straight line connecting the beginning point and the answer). Examples of navigation efficiency are shown in Table 6 below.

Response behaviors metrics refer to behaviors performed on the question directly (e.g., changing answers, hovering over question, etc.). Examples of response behaviors are shown in Table 7 below.

Time based metrics refer to timing between events. Examples of time metrics are shown in Table 8 below.

TABLE 6
Example metrics for measuring Navigation Efficiency

| Metric | Explanation/Example of bias |
|---|---|
| Deviation | If deviation decreases, this is an indicator that respondents are |
| | answering faster, and giving less taught to questions/answers. |
| | An increase in deviation on a question indicates that a person is |
| | cognitively debating how to answer a question. |
| Deviation normalized by length | This is the same as deviation, but it normalized by the required |
| | distance between questions and answers to eliminate noise. |
| Deviation normalized by length | This is the same as deviation, but it normalized by the required |
| and speed | distance between questions/answers and speed to eliminate noise. |
| | This statistic is helpful for ensuring the change in deviation is due to |
| | less or more thought, rather than decreased or increased distance and |
| | speed. |
| Direction changes on the x (for | An increase in direction changes indicates that respondents are |
| horizontally aligned answers) | debating more between multiple answers. Few direction changes |
| and y axis (for vertically aligned | mean that respondents are giving less taught to the questions. |
| answers) | |
| Direction changes normalized by | Same as direction changes, except normalized for the complexity of a |
| distance on the x (for | question (measure in distance). This eliminates noise caused by |
| horizontally aligned answers) | different question layouts. |
| and y axis (for vertically aligned | |
| answers) | |

TABLE 7
Example metrics for measuring Response Behaviors

| Metric | Explanation/Example of bias |
|---|---|
| AutoFill | A detected autofill would indicate that the answers are being filled out |
| | by a bot and therefore indicate poor data quality. |
| Copy Paste | A detected copy paste action could indicate respondents are inserting |
| | canned responses, which is an indicator of poor data quality in many |
| | contexts. |
| Hover | A detected hover over another answer could indicate that a person is |
| | consider a different, maybe more truthful, answer. |
| Switched | A detected answer switch may indicate indecision in answering, an |
| | indicator of data quality. |
| High Magnitude of Change | If an answer changes by a given large amount, it may indicate that a |
| | person is changes his or her mind substantially on a question (note, this |
| | can be filtered to exclude large changes that are due to noise, such as |
| | forgetting a 0 when typing a large number). |
| Low Magnitude of Change | If an answer changes by a given small amount, it may indicate that a |
| | person is refining an answer, an indicator of data quality. |
| Number Of Changes | The number of change may indicate data quality. Too few changes, may |
| | indicate not giving enough thought. Too many changes, may indicate a |
| | biased response. |
| Number and Magnitude of | When a minor pause (gauged by a time predetermined threshold) is |
| Inline Text Pauses | detected in a data input, it indicates respondents are checking data for |
| | accuracy or debating on altering the answer. A large pause may indicate |
| | high cognitive conflict and load, or disengagement with the survey. |
| Leaving the page | A detected exit and reenter from the page may indicate that a person is |
| | not engaged in the survey. |

TABLE 8
Example metrics for measuring Time

| | |
|---|---|
| Average tap (touch screens) or | If tap/click time becomes consistently faster, it indicates that |
| click (mouse) time | respondents are giving less taught to the questions/answers and vice |
| | versa. |
| | If tap/click time becomes slower on a given question, it indicates a |
| | person has cognitive load in choosing the answer. |
| Average acceleration and speed | If a person has increased acceleration and/or speed in the first 750 |
| in the first 750 ms | ms, it indicates that they are moving to answer before they have had a |
| | chance to read the question. |
| Keystroke duration (time it takes | If respondent's keystroke duration increases, this many indicate a) |
| to push and release a key on the | increased cognitive load or b) fatigue. |
| keyboard) | If person's keystroke duration decreases, it may be mean that a person |
| | is trying to get through a survey faster. |
| Keystroke transition (time | If respondent's keystroke duration increases it means a) increased |
| between keystrokes) | cognitive load, b) fatigue, or c) a lack of familiarity. |
| | If person's keystroke duration decreases, it may be mean that they are |
| | a) more familiar with a context or b) trying to get through a survey |
| | faster. |
| Speed and idle time ratio | If a person moves slower while at the same time taking more time |
| | breaks, it can indicate that a person is thinking more (high cognitive |
| | load) about an answer. |
| speed_overall | Higher speed, could mean a person is satisficing (trying to just finish |
| | the survey). Slower speed might mean a person is debating how to |
| | answer a question. |
| Time_break | A small increase in time breaks or pauses could mean greater |
| | engagement (giving questions more thought), large increases in time |
| | breaks could mean disengagement as respondents are leaving the |
| | screen. |
| total_time | A small increase in time could mean greater engagement (giving |
| | questions more thought), large increases in time breaks could mean |
| | disengagement as respondents are distracted. |

### Normalize Metrics (Step 1904)

So that data in each category can be compared and combined, the time-based metrics and the navigation efficiency metrics must be normalized (note, response behavior metrics are already normalized as binary (T/F)).

To normalize the time-based metrics, a centering and scaling process must take place. This process entails calculating the mean and standard deviation for each metric. Then, the mean is subtracted from each value, and the difference is divided by the standard deviation. This converts all continuous metrics to a similar scale.

Aggregate Raw Metrics into Three Meta Variables: A) Navigation Efficiency, b) Response Behaviors and c) time metrics (Step 1906)

Next, the numerous metrics must be combined into three indicators of response bias: navigation efficiency, response behaviors, and time metrics.

Multiple techniques can be used to combine the metrics in each category into a meta score (e.g., weighted averages, regressions, factor analysis, etc.). Here we describe one example.

For the continuous metrics (navigation efficiency and time metrics), the metrics for each category can be grouped for each participant, and then the median value can be taken for each participant for navigation efficiency and time metrics.

For the response behaviors metrics, the number of TRUE cases can be summed to create a combined metric.

The three combined metrics are referred to as Response Bias Scores (RBS).

### Use Meta Variables to Detect Adjust for Response Bias in Relationships (Step 1908)

The three combined metrics can be used to detect and control for response bias in analyses.

To check for response bias, the metrics are used to statistically moderate the relationship between collected self-reported variables (survey items) and an outcome. If the moderating relationship is significant, this indicates that a response bias is present.

The moderating relationship can be adjusted for by multiplying the self-reported variables (survey items) by the significant moderating variables (navigation efficiency, response behaviors, and time metrics). Other adjusting techniques can be used as well, such as squaring, cubing, or adjusting the moderating variable before combining with the self-report variables.

Alternatively, significant moderating variables can be used to filter out biased data, and therefore have cleaned data for analysis.

### Deploying the Present System and Method

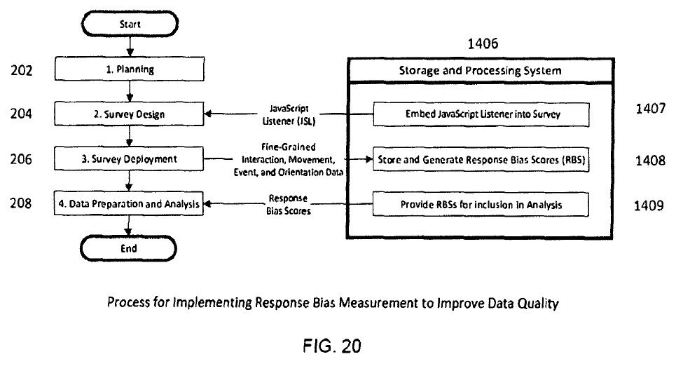

Deploying an online survey is a four-step process that includes planning, survey design, survey deployment, and data preparation and analysis. This innovation aids in detecting and measuring various types of response biases by embedding a Raw Data Collector (RDC) into an online survey. The RDC captures various types of data including navigation, question answering behaviors, time, and other types of events at millisecond precision. This fine-grained data sent from the online survey to a Storage and Processing System (SPS), where Response Bias Scores (RBS) are calculated and stored. Once the execution of the online survey is completed, RBS are provided for inclusion in data analysis (FIG. 20).

FIG. 20 shows an exemplary process for implementing response bias measurement to improve data quality. Specifically, FIG. 20 shows how the Storage and Processing System 1406 interacts with the online survey process shown in FIG. 2. As previously shown in FIG. 2, the process commences with survey planning 202 and survey design 204. At step 206, the survey is deployed, exemplarily online, to be taken by users. At step 208, the data from the survey is collected, prepared (e.g. parsed), and then analyzed to make determinations.

At the Storage and Processing System 1406, the system embeds the JavaScript Listener 1407 into the online survey of FIG. 2. It should be apparent to one of ordinary skill in the art that the JavaScript Listener 1407 is software that may be coded in any programming language that is compatible with the computer systems of the present invention. The Storage and Processing System 1406 also receives fine-grained interaction, movement, event, and orientation data from the survey deployment 206. Then, the system 1406 stores and generates response bias scores from the data 1408, in manners explained in the disclosure. Having generated the scores, the system 1406 then transmits the response bias scores 1409 to be used in the online survey's data preparation and analysis 208.

### Benefits of the Innovation

This innovation provides three important benefits over existing approaches for dealing with response biases. First, Response Bias Scores (RBS) can be used to identify if response biases are present in a study; i.e., when the RBS do not significantly moderate the relationship between a survey construct and predictor variable, a response bias in not present. Second, RBS provide novel insight into understanding how response biases influence relationships that are often difficult or impossible to obtain through other measures and approaches. Third, and most importantly, the statistical metrics used to capture RBS helps to account for various types of response biases in predictive statistical models, thus improving the explanatory power of the relationship between a survey construct and predictor variable.

### Computing System

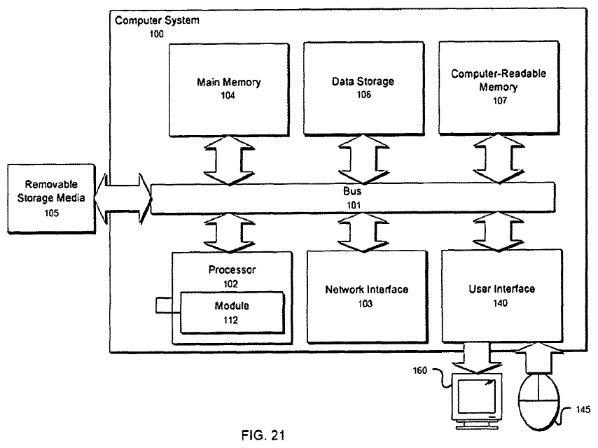

FIG. 21 illustrates an example of a suitable computing system 100 used to implement various aspects of the present system and methods for detecting and analyzing response bias in online surveys. Example embodiments described herein may be implemented at least in part in electronic circuitry; in computer hardware executing firmware and/or software instructions; and/or in combinations thereof. Example embodiments also may be implemented using a computer program product (e.g., a computer program tangibly or non-transitorily embodied in a machine-readable medium and including instructions for execution by, or to control the operation of, a data processing apparatus, such as, for example, one or more programmable processors or computers). A computer program may be written in any form of programming language, including compiled or interpreted languages, and may be deployed in any form, including as a stand-alone program or as a subroutine or other unit suitable for use in a computing environment. Also, a computer program can be deployed to be executed on one computer, or to be executed on multiple computers at one site or distributed across multiple sites and interconnected by a communication network.

Certain embodiments are described herein as including one or more modules 112. Such modules 112 are hardware-implemented, and thus include at least one tangible unit capable of performing certain operations and may be configured or arranged in a certain manner. For example, a hardware-implemented module 112 may comprise dedicated circuitry that is permanently configured (e.g., as a special-purpose processor, such as a field-programmable gate array (FPGA) or an application-specific integrated circuit (ASIC) to perform certain operations. A hardware-implemented module 112 may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module 112 that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules 112 are temporarily configured (e.g., programmed), each of the hardware-implemented modules 112 need not be configured or instantiated at any one instance in time. For example, where the hardware-implemented modules 112 comprise a general-purpose processor configured using software, the general-purpose processor may be configured as respective different hardware-implemented modules 112 at different times. Software may accordingly configure a processor 102, for example, to constitute a particular hardware-implemented module at one instance of time and to constitute a different hardware-implemented module 112 at a different instance of time.

Hardware-implemented modules 112 may provide information to, and/or receive information from, other hardware-implemented modules 112. Accordingly, the described hardware-implemented modules 112 may be regarded as being communicatively coupled. Where multiple of such hardware-implemented modules 112 exist contemporaneously, communications may be achieved through signal transmission (e.g., over appropriate circuits and buses) that connect the hardware-implemented modules. In embodiments in which multiple hardware-implemented modules 112 are configured or instantiated at different times, communications between such hardware-implemented modules may be achieved, for example, through the storage and retrieval of information in memory structures to which the multiple hardware-implemented modules 112 have access. For example, one hardware-implemented module 112 may perform an operation, and may store the output of that operation in a memory device to which it is communicatively coupled. A further hardware-implemented module 112 may then, at a later time, access the memory device to retrieve and process the stored output. Hardware-implemented modules 112 may also initiate communications with input or output devices.

As illustrated, the computing system 100 may be a general purpose computing device, although it is contemplated that the computing system 100 may include other computing systems, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments that include any of the above computing systems or devices, and the like.

Components of the general purpose computing device may include various hardware components, such as a processor 102, a main memory 104 (e.g., a system memory), and a system bus 101 that couples various system components of the general purpose computing device to the processor 102. The system bus 101 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing system 100 may further include a variety of computer-readable media 107 that includes removable/non-removable media and volatile/nonvolatile media, but excludes transitory propagated signals. Computer-readable media 107 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the general purpose computing device. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 104 includes computer storage media in the form of volatile/nonvolatile memory such as read only memory (ROM) and random access memory (RAM). A basic input/output system (BIOS), containing the basic routines that help to transfer information between elements within the general purpose computing device (e.g., during start-up) is typically stored in ROM. RAM typically contains data and/or program modules that are immediately accessible to and/or presently being operated on by processor 102. For example, in one embodiment, data storage 106 holds an operating system, application programs, and other program modules and program data.

Data storage 106 may also include other removable/non-removable, volatile/nonvolatile computer storage media. For example, data storage 106 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules and other data for the general purpose computing device 100.

A user may enter commands and information through a user interface 140 or other input devices 145 such as a tablet, electronic digitizer, a microphone, keyboard, and/or pointing device, commonly referred to as mouse, trackball or touch pad. Other input devices 145 may include a joystick, game pad, satellite dish, scanner, or the like. Additionally, voice inputs, gesture inputs (e.g., via hands or fingers), or other natural user interfaces may also be used with the appropriate input devices, such as a microphone, camera, tablet, touch pad, glove, or other sensor. These and other input devices 145 are often connected to the processor 102 through a user interface 140 that is coupled to the system bus 101, but may be connected by other interface and bus structures, such as a parallel port, game port or a universal serial bus (USB). A monitor 160 or other type of display device is also connected to the system bus 101 via user interface 140, such as a video interface. The monitor 160 may also be integrated with a touch-screen panel or the like.

The general purpose computing device may operate in a networked or cloud-computing environment using logical connections of a network interface 103 to one or more remote devices, such as a remote computer. The remote computer may be a personal computer, a server, a router, a network PC, a peer device or other common network node, and typically includes many or all of the elements described above relative to the general purpose computing device. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the general purpose computing device may be connected to a public and/or private network through the network interface 103. In such embodiments, a modem or other means for establishing communications over the network is connected to the system bus 101 via the network interface 103 or other appropriate mechanism. A wireless networking component including an interface and antenna may be coupled through a suitable device such as an access point or peer computer to a network. In a networked environment, program modules depicted relative to the general purpose computing device, or portions thereof, may be stored in the remote memory storage device.

The system and method of the present invention may be implemented by computer software that permits the accessing of data from an electronic information source. The software and the information in accordance with the invention may be within a single, free-standing computer or it may be in a central computer networked to a group of other computers or other electronic devices. The information may be stored on a computer hard drive, on a CD-ROM disk or on any other appropriate data storage device.

The foregoing description and drawings should be considered as illustrative only of the principles of the invention. The invention is not intended to be limited by the preferred embodiment and may be implemented in a variety of ways that will be clear to one of ordinary skill in the art. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

1. A method for predicting response bias comprising:
receiving data associated with a user's input device in the course of a survey;
calculating one or more metrics from the data, wherein the metrics are a measure of the movements or usage events associated with the input device;
calculating the user's response bias from the one or more metrics; and
outputting results of the survey, wherein the results are adjusted for the user's response bias.

2. The method of claim 1, wherein the response bias is calculated as one or more response bias scores.

3. The method of claim 2, wherein the one or more response bias scores are calculated using weighted averaging, regression, and/or factor analysis.

4. The method of claim 1, wherein the metrics are based on the user's navigation efficiency, response behaviors, and time for each of the one or more metrics.

5. The method of claim 1, wherein the received data is comprised of a range of movement, navigation speed and accuracy, orientation, data entry, and events.

6. The method of claim 1, further comprising normalizing the one or more metrics.

7. The method of claim 1, wherein the received data comprises human-computer interaction behaviors.

8. The method of claim 7, further comprising applying signal isolation on the human-computer interactions.

9. The method of claim 8, further comprising assigning an identifier to the data, wherein the data is related to a survey question or a region of interest on the survey.

10. The method of claim 1, wherein the response bias is calculated to exist when there is a moderating relationship between items on the survey and the one or more metrics.

11. A non-transitory computer readable storage medium storing a computer program that, when executed, causes a computer to:
receive data associated with a user's input device in the course of a survey;
calculate one or more metrics from the data, wherein the metrics are a measure of the movements or usage events associated with the input device;
calculate the user's response bias from the metrics; and
output results of the survey, wherein the results are adjusted for the user's response bias.

12. The non-transitory computer readable storage medium of claim 11, wherein the response bias is calculated as one or more response bias scores.

13. The non-transitory computer readable storage medium of claim 12, wherein the one or more response bias scores are calculated using weighted averaging, regression, and/or factor analysis.

14. The non-transitory computer readable storage medium of claim 11, wherein the metrics are based on the user's navigation efficiency, response behaviors, and time for each of the one or more metrics.

15. The non-transitory computer readable storage medium of claim 11, wherein the received data is comprised of a range of movement, navigation speed and accuracy, orientation, data entry, and events.

16. The non-transitory computer readable storage medium of claim 11, wherein the computer program, when executed, further causes the computer to normalize the one or more metrics.

17. The non-transitory computer readable storage medium of claim 11, wherein the received data comprises human-computer interaction behaviors.

18. The non-transitory computer readable storage medium of claim 17, wherein the computer program, when executed, further causes the computer to apply signal isolation on the human-computer interactions.

19. The non-transitory computer readable storage medium of claim 18, wherein the computer program, when executed, further causes the computer to assign an identifier to the data, wherein the data is related to a survey question or a region of interest on the survey.

20. The non-transitory computer readable storage medium of claim 11, wherein the response bias is calculated to exist when there is a moderating relationship between items on the survey and the one or more metrics.
